(19) United States
(12) Patent Application Publication
(10) Pub. No.: US 2019/0278796 A1
(43) Pub. Date: Sep. 12, 2019

(54) Method and system for searching, publishing and managing the lite cycle of multimedia contents related to public events and the user experience

(71) Applicant: DOGMA srl., Napoli (IT)

(72) Inventor: Domenico LELLIS, London (GB)

(21) Appl. No.: 16/334,777

(22) PCT Filed: Sep. 22, 2016
(86) PCT No.: PCT/IT2016/000218

§ 371 Date: Mar. 20, 2019

(51) Int. Cl. G06F 16/435; G06F 16/48; G06F 16/44; G06F 16/901; G06Q 50/00

(52) U.S. Cl. CPC G06F 16/435; G06F 16/48; G06Q 50/01; G06F 16/9024; G06F 16/44

(57) ABSTRACT

Method and system for searching, publishing and managing the life cycle of multimedia contents related to public events and the user experience. The invention relates to a computer system and a method for the management of the life cycle of multimedia content related to public events, such as concerts, sports events and the like, and made the correlation between events and also personal content in order to build a multimedia “knowledge base” dynamic and personalized. There are two distinct phases in the life cycle of multimedia content: the first (a) when creating an event within the platform; the second (ω) starting from the end of the event (post-event). The data are taken from news, messages, photos, videos, comments, tweets, etc. through semantic analysis techniques of massive and unstructured information (place, time, relationships, moods, . . . ).

This invention refers, in general, to the processing of data in electronic form or also refers to methods, computer programmes and systems for detecting events and multimedia content and their publication, making the correlation between events and also personal content in order to build a dynamic and customised multimedia “knowledge base”.

### STATE OF THE ART

There are several known patents describing event detection methods and systems for various purposes. For example, the applicant knows about the existence of the WO2016012493 patent, which describes a system and a related method that uses various sources of social media for detecting events in each category and size, even on a small scale, that perform aggregations of individuals in a certain place and during a certain time, for security applications. In this patent, a cluster of stored data items is formed and data cluster items are identified by comparing essentially the time values and position values in a range; in other words, the algorithm detects an event if the cluster exceeds an event detection threshold value.

The applicant also knows about the existence of Patent 2012P01032WO. This is the patent which describes a method and a system for detecting crowds, watching and monitoring them before, during and after their formation, which makes use of an appropriate interface configured to communicate with Facebook or Twitter social media services. Also, the data set of a single crowd component is labelled with the location coordinates and time coordinates. The system allows to control what is happening around a certain place for safety purposes always.

The patent US 20160034712 A1 describes a system and method that allows the detection of an event and its content, including receiving a plurality of messages from a plurality of social networking systems; indexing each post; the detection of an event in a georeferenced base; to identify an event of interest based on the event parameter values; to notify a user account when the detected event is of interest to the user account; to aggregate event messages in a stream of content for the user account; to facilitate the interaction of the user account with the use of event messages.

According to recent news, the company Instagram has launched a new feature called Instagram Stories for IOS, Android and Windows Mobile systems, which identifies the information that matters the most to users and places it at the top of their feed. Each user sees the stories of the people they follow and lets you share all their daily moments. When followed profiles publish a new story, a red circle appears around their profile photo; to see someone's story, just touch his/her profile photo: photos and videos that make up the story disappear after 24 hours without appearing on the profile or feed; reactions or comments remain private: it is possible to interact only through the direct messaging system. Public comments or “Likes” are not allowed.

Each of these systems that we mentioned above are, however, proposed with various modes and algorithms. In fact, the applicant is not aware of any publishing system which uses content and the technical procedures that will be described below, allowing to simultaneously analyse social media sources as well as to extract information, to analyse it semantically, to classify it, to integrate it with an editorial contribution and enrich a knowledge base; Moreover, through users, in other words, by means of user preferences (Facebook “likes”, . . . ), from users' activity, time and context (the “where” and “when”) and their affective state, the system searches, filters and segments information in the knowledge base to provide users with a customised production to be shared within the same knowledge base. And finally, the system enables the “Take-Me-Back” experience, creating their own multimedia content for sharing.

### Aims and Advantages of the Invention

The aim, therefore, of this invention is to provide a method and a system that with the use of different text analysis and extraction integrated techniques with a subsequent classification of content based on ontology-based mapping, enriches and increasingly populates a knowledge base by extracting, analysing and classifying semantic data taken from the internet; essentially events and heterogeneous resources, and on user input, searches, filters and segments the information in this knowledge base from the user preference (Facebook “likes”, . . . ), user activity, time and context (the “where” and “when”) and the affective state, so as to influence the overall display of the contents to build a personal environment to share within the knowledge base itself.

Another scope of this invention, in addition to and in agreement with the previous one, is to create a method and a system for managing the life cycle of multimedia content related to public events, such as concerts, sports events and the like that allows users not only to query texts, images, video, entered by the editors or other platform users, referring to that event, but also to include their own content in order to create a unique experience of the event itself, in its various stages (before, during, after).

Also, this invention, in addition to and in agreement with the previously mentioned scopes, aims to provide a method and a system for managing a multimedia content knowledge base so that each user can enjoy a custom view based on their preferences and, simultaneously, for all content presented to users to be subject to a rating.

This invention, in addition to and in agreement with previous scopes also aims to create a computer system, essentially a platform interface with users. In other words, a client PCs or mobile devices such as smartphones or tablet PC, configured, even electronically, to receive and display a plurality of media data in the aforesaid form and manner.

Lastly, this invention, in addition to and in agreement with previous scopes also aims to create a computer system, essentially a virtual machine that is manifested through an assembly of computer programmes that perform the invention method's steps, through one or more programmable processors, by operating on input data and generating output data.

### DESCRIPTION OF DRAWINGS

FIG. 1 shows the various stages of the creation of an event within the knowledge base system with the scanning of sources, extraction of information, the semantic analysis and classification up to its enrichment, according to the invention.

FIG. 2 shows the various stages of the system from the end of the event on which, on user input, searches are made, information is filtered and segmented by means of user profiling techniques, and the content is subjected to a coherence rating and to a likes/dislikes request. The “Take-Me-Back” experience is enabled for users, according to the invention.

FIG. 3 shows a graph structure relating to an event, according to the invention.

FIG. 4 shows the new graph that enters the event, joining a graph structure of the knowledge base, and which edits it by eliminating redundant information.

FIG. 5 shows, on the basis of the user's profile, part of the knowledge base referring to the chosen event which can be customised and browsed.

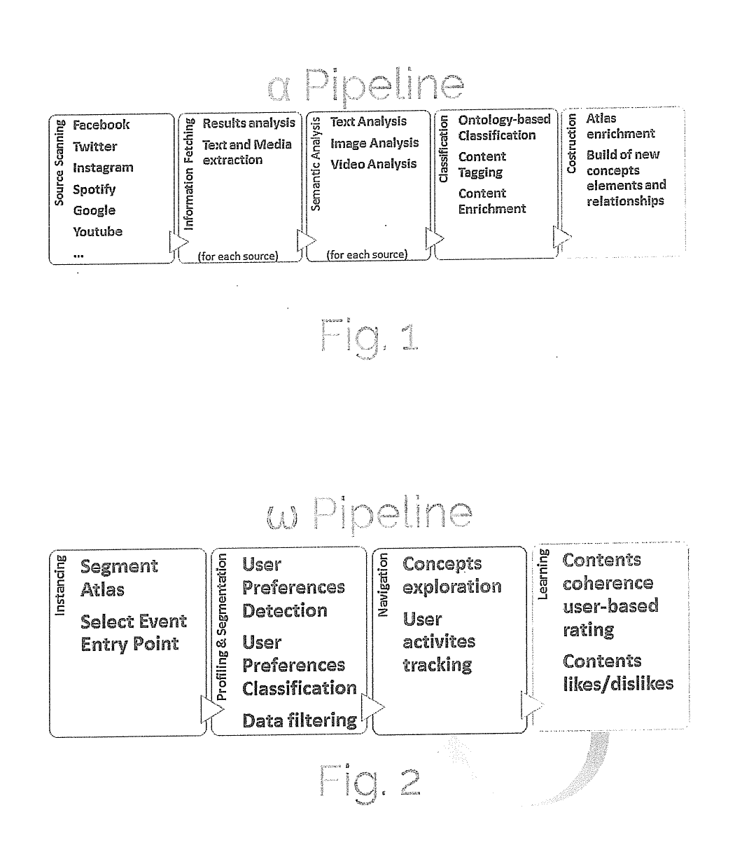

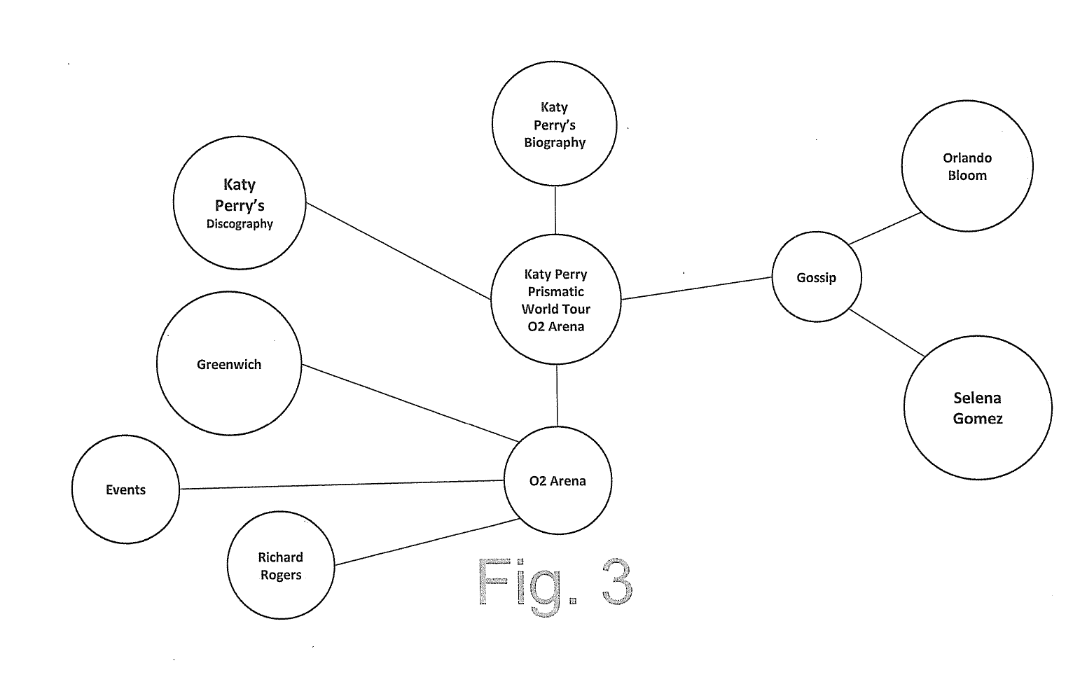

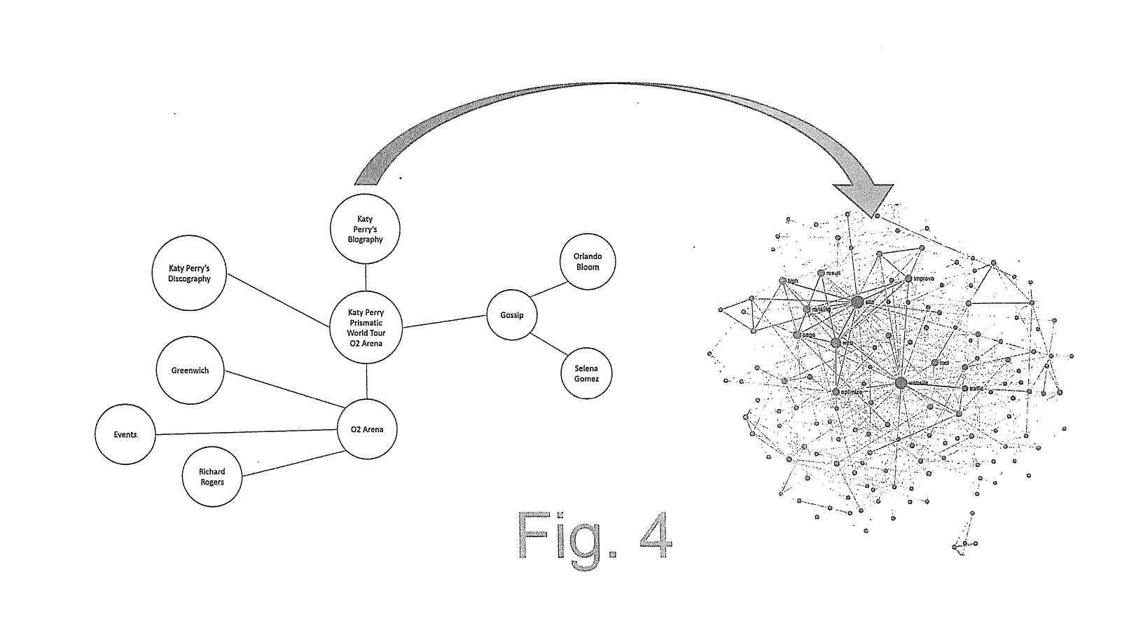

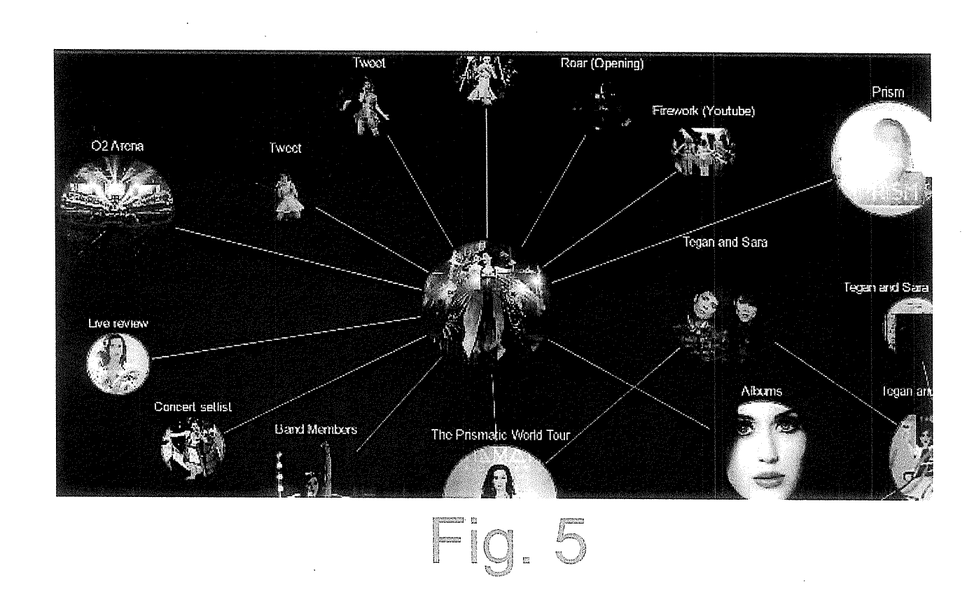

In accordance to the accompanying drawings, the system is based on a platform that draws information from structured and unstructured sources to enrich the knowledge base: each source requires a dedicated pipeline for information analysis and extraction. Data is obtained from news, messages, photos, videos, comments, tweets, etc. through semantic analysis techniques on massive and unstructured information (place, time, relationships, moods, . . . ).

There are two distinct phases in the life cycle of multimedia content: the first (α) phase is the creation of an event within the platform; the second (ω) begins when the event ends (post-event).

### Description of the Method and the System within

The method, according to this invention, is expressed, as was mentioned before, firstly, with the creation of an event and by scanning data sources on the web and social media, it extracts information, analyses it semantically, classifies it and it enriches the knowledge base. This process, called a Pipeline, includes four main phases and the relevant sub-phases:
Information ingestion
   Results analysis
   Text and Media extraction
   Ontology e linking data
Semantic Analysys
   Text Analysis
   Image Analysis
   Video Analysis
   Affective Analysis
Classification
   Ontology Based Classification
   Content Tagging
   Content Enrichment
   Filtering
Costruction
   Atlas Enrichment
   Built of new concepts
   Elements and relationship

Secondly, the ω Pipeline, through the user, searches, filters and segments the information in the knowledge base in accordance with user preferences (Facebook “likes”, . . . ), user activity, time and context (“where” and “when”) and the affective state, and enables the “Take-Me-Back” experience so users can produce a customised video of their experience. The phases and the related sub-phases of ω Pipeline are listed below:
Istancing
   Segment <<Atlas of Knowledge>>
   Select Event Entry Point
Profiling and Segmentation
   User Preferences Detection
   User Preferences Classification
   User Affective State
   Data filtering
Navigation
   Concepts exploration
   User activites tracking
Learning
   Content coherence user-based rating
   Content likes/dislikes

This invention's method is based on the construction of an original algorithm that uses some existing technologies such as:
Big Data approach
Semantic Methods: ontologies
Semantic technologies (i.e. RDF-OWL-XML)
Conventional and NoSQL Database
Sentiment Analysis
Affective API

Algorithm components and their functions are described in more detail below. The algorithm can be broken down into two components, the first component (α) aims to produce and enrich a knowledge base organised by adopting a graph structure in which each node represents a concept and the arcs represent relationships between concepts. This structure is called the Knowledge Atlas.

The second component (ω) of the algorithm is designed to produce a customised environment of the Atlas of knowledge for each individual user.

The first component (α) of the algorithm is based on text analysis and extraction techniques with a subsequent classification of content based on ontology-based mapping. It uses a combination of different technologies and text processing and processes images with subsequent harmonisation of data within the knowledge base known as the Knowledge Atlas.

Inside the Atlas each item of information is associated to a “concept” that represents a set of elements united by some characteristics processed following the classification of input data. The algorithm (α) is structured in three distinct processing stages.

The first phase of the algorithm provides for the access, collection and structuring of content made available from services such as existing social networks on the Internet.

In detail: the process begins by means of automatic activation following the creation and/or publication of content relating to an “event” by a user. The process activation provides for the preparation of input data used to begin the database research and enrichment process. Input data is as follows: event name, event type, description, locations, dates;

To scan font sources, the algorithm uses a set of N fonts previously configured using access to social networks and channels through public APIs provided by different providers of data access services (e.g. Facebook, Twitter, Spotify). For each source, the algorithm performs data searches using the information received as input; raw data are the results of research conducted in parallel on each data source subject to scanning. For each item received in response (for example: messages in the case of Twitter, video posts on You-tube, comments on Spotify music tracks) the algorithm performs a data extraction process in accordance with a pre-configured structure and associated with each source (for example, Twitter will have text, images and hashtags).

Each element received in response from each source is subjected to an analysis and separation of the content according to the following rules:
separation of simple text (not associated with images and other multimedia content)
separation of images with accompanying attributes (text, comments);
separation of video with accompanying attributes (text, comments);
separation of links to external multimedia type sources (images, videos);
separation of links to other types of external sources.

The second phase of the algorithm involves the analysis of various sources in order to classify content based on the concepts contained in the ontology used for classification: for each extracted text, a classification based on the “Latent Dirichlet Allocation” (LDA) algorithm is applied, adopting specific vocabularies in each language enriched by a dedicated taxonomy containing terms for the types of events submitted subject to the method (taxonomy may contain terms relating to the type of event, e.g., concert, or related to the specific event, such as sponsors' names). The output of this step is a list of the key concepts extracted from the accompanying text. Based on the types of sources and extract text, it will be possible to apply a preliminary filter application of the LDA algorithm that provides for the elimination of “stop-words” or common, generic words which are ancillary to the main words such as, for example, articles and conjunctions. The application of the algorithm to eliminate stop-words involves the use of a simple vocabulary with basic research of the terms to be deleted.

For each extracted image, the algorithm KLT (Kanade-Lucas_Tomasi) is applied for face detection within the scene; then an algorithm of face matching is applied based on support vector machines to classify each detected face with respect to the multimedia materials provided with the creation of the event; This step allows to extract and classify images containing important subjects related to concerts. At the end of the algorithm, the Latent Semantic Analysis based classification extracts the text accompanying the image using a standard terms vector provided during input and existing within the knowledge base. The output of this step is a list of terms related to the concepts expressed in the accompanying text and the list of recognized faces in the image(s).

For each video, the title and accompanying text is extracted and classified by applying the Latent Semantic Analysis algorithm.

The last step of the algorithm consists of two steps focused on enriching the information collected and classified, and the subsequent introduction of data within the Atlas of knowledge.

Each extract content item is subjected to a “local” enrichment process that uses only extracted information from sources. The algorithm adopts an enrichment-tag process to insert in each element listed some key terms extracted from other elements and not present in the element under analysis. For example, a message containing a location will be accompanied by including information that the concert will use the place as a performance stage.

Any content available will be placed inside the Atlas of Basic knowledge based on the concepts and significant terms extracted during the analysis phase (Ontology Enrichment); this step will contribute to the creation of new nodes if concepts not yet present within the Atlas are detected or during the enrichment of pre-existing with new items when concepts already present are detected.

Following processing, the algorithm will produce a new updated version of the Atlas of Knowledge containing text, images and videos associated with pre-existing concepts or new concepts.

Part (ω) of the algorithm is based on user profiling techniques, to partition the Atlas knowledge base so that each user can enjoy a customised experience according their own preferences and, simultaneously, for all content presented to users be submitted for rating that affects the overall display of the contents. The analysis algorithm of user preferences is based on the combination of two of the processing operations described in the following data.

The first processing static-type operation, provides for the partitioning of the Atlas knowledge structure by collecting and classifying user preferences.

The first processing operation is based on following step:
extracting user preferences by accessing and collecting data from the Facebook profile and/or Instagram and other social networks;
direct integration of user preferences through the use of appropriate user interfaces and manual selection of favourite topics presented in the form of tag list;
construction of the user's preference map on the concepts expressed in the Atlas; the mapping operation is performed using a matching graph between user preferences and Atlas knowledge concepts.

The second dynamic-type processing operation, takes place when the user browses the Atlas and consists in the finishing of preferences. Browsing within the Atlas is made possible by presenting the user with a browseable graph of concepts associated with a specific event subject to consultation activities; this graph represents a subset of the Knowledge Atlas. While navigating, users can see the details of content and express likes or dislikes of displayed information.

Following feedback on the content, the algorithm adopts a collaborative filtering technique producing triple-type data as follows: User, Item, Rating. The triple-type data set is stored on a database used for storing all preferences expressed by users; for every preference expressed, the KNN algorithm (K-Nearest Neighbour) is applied to define or update the community reference preference (preferably aforesaid). All content classified below a definable threshold, will not be shown any longer to users, allowing, in this way, to eliminate the representation of content not deemed acceptable by the community.

The list of elements making up the customised knowledge atlas for each user, will enable the completion of the experience through the construction of the “Take-Me-Back” video produced automatically by the system.

### Application Example

Imagine that we cover the entire life cycle of an event in the environment platform of the system under this invention. We use “Katy Perry's O2 arena concert as part of the Prismatic World Tour” as an event. When the event is created within the platform, the network is scanned (Katy Perry Prismatic World Tour, O2 Arena, Band Members, . . . ), a series of multimedia content items related to the event (a pipeline) are extracted and catalogued and a graph is built on that event. This new graph will join the knowledge base by eliminating redundant elements (e.g. O2 arena may already exist).

A few days after the concert has taken place, a platform user using the App, selects the event “Katy Perry's O2 Arena concert” under the “Prismatic World Tour”. Here, the user will find content posted by the editors and will be able to add their own content and launch the programme to see what it suggests (w pipeline); based on the user profile, his/her preferences and everything described above, the result of the algorithm will be a new Atlas knowledge part, customised and browseable. Now the user will be able to browse through the proposed content and select a subset to be used for creating the “Take-me-back” video.

Embodiments of the invention can be implemented in digital electronic circuitry, or hardware, firmware, software, or in combinations of them.

The invention can be implemented as a computer programme product, i.e., a computer programme residing, for example, in a machine-readable memory device, or in a programmable processor, a computer, or multiple computers.

The computer programme may be written in any programming language and can be deployed in any form, including as a stand-alone programme or as a module, a subroutine, or other unit suitable for use in a computing environment.

The computer programme can be distributed and run on a computer or on multiple computers at one site or distributed across multiple sites and interconnected by a communication network.

The invention method's stages can be performed by one or more programmable processors, running the computer programme, to perform the invention's functions by operating on input data and generating output data.

To provide interaction with users, the invention can be implemented on a computer having a display device and an input device such as a keyboard, touchscreen or touchpad, a pointing device, for example, a mouse or a trackball. Other kinds of devices can be used to provide interaction with users.

The invention can be implemented in a computing system that includes a back-end component, for example, a data server, or that includes a middleware component, e.g., an application server, or that includes a front-end component for example, a client computer having a graphical user interface or a Web browser through which users can interact with the embodiment of the invention, or any combination of such back-end, middleware, or front-end components.

Client computers can also be mobile devices, like smartphones, tablet PCs or other computing and communication handheld or wearable devices. Components of the system can be interconnected by any form or medium of digital data communication, e.g., a communications network. Examples of communication networks include the Internet or LAN or wireless telecommunications networks.

The computing system can include clients and servers. A client and server are generally remote from each other and typically interact through a communications network.

1) A computer system for searching, publishing and managing the life cycle of multimedia content related to public events and the user experience, including an interface platform with users, i.e. a client computer or mobile device connected to a communication network, one or more databases, and a set of computer programmes, essentially an algorithm comprising a pipeline (α) and a pipeline (ω), which via one or more programmable processors, operates on input data, analyses semantically and extracts information from web data sources and social media; the system ranks them according to mapping based on ontologies, organising them in a graph structure to create the knowledge base; furthermore, on the basis of user input, by means of user preferences (Facebook “likes”, . . . ), user activity, time and context (the “where” and “when”) and affective state, the system searches, filters and segments the information on the aforementioned knowledge base to provide users with output data, especially with a customised environment of output data to be shared within the same knowledge base; and finally the system enables the “Take-Me-Back” experience, automatically creating own multimedia content shared within the knowledge base.

2) A computer system as in claim 1) where at least one of the databases is of the NoSQI type, and contains a graph structure of the events knowledge base, built and enriched with the algorithm pipeline (α), and partitioned on the basis of user input with the algorithm pipeline (ω).

3) A computer system and a method for searching, publishing and managing the life cycle of multimedia content related to public events and the user experience, that through an interface platform with users, i.e. a client computer or mobile device connected to a communication network, one or more databases, and a set of computer programmes, essentially an algorithm comprising a pipeline (α) and a pipeline (ω), which via one or more programmable processors, operates on input data, analyses semantically and extracts information from web data sources and social media; The system ranks them according to mapping based on ontologies, organising them in a graph structure to create the knowledge base; Furthermore, on the basis of user input, by means of user preferences (Facebook “likes”, . . . ), user activity, time and context (the “where” and “when”) and affective state, the system searches, filters and segments the information on the aforementioned knowledge base to provide users with output data, especially with a customised environment of output data to be shared within the same knowledge base; and finally the system enables the “Take-Me-Back” experience, automatically creating own multimedia content shared within the knowledge base.

4) A computer system and a method implemented on a client computer or mobile device for searching, publishing and managing the life cycle of multimedia content related to public events and the user experience as claim 3) characterised by the fact that input in the algorithm data pipeline (α) is as follows: event name, event type, description, locations, dates.

5) A computer system and a method for searching, publishing and managing the life cycle of multimedia content related to public events and the user experience as claim 3) characterised by the fact that in the graph structure, each node represents a concept or a set of information elements which highlight common features processed following the classification of input data, and the arcs represent relationships between concepts.

6) A computer system and a method for searching, publishing and managing the life cycle of multimedia content related to public events and the user experience as claim 3) characterised by the fact that each element received in response from each web data sources and social media is subjected to an analysis and separation of the content according to the following rules: separation of simple text (not associated with images and other multimedia content); separation of images with accompanying attributes (text, comments); separation of video with accompanying attributes (text, comments); separation of links to external multimedia type sources (images, videos); separation of links to other types of external sources.

7) A computer system and a method for searching, publishing and managing the life cycle of multimedia content related to public events and the user experience as claims 3), 6) characterised by the fact that for each simple text, without stop-words, a classification based on the “Latent Dirichlet Allocation” (LDA) algorithm applies, by adopting specific vocabularies for each language enriched by a dedicated taxonomy containing dedicated terms for the types of events, and obtaining a list of key concepts; for each extracted image, the KLT (Kanade-Lucas_Tomasi) algorithm for detecting faces in the scene is applied and then an algorithm of face matching is applied based on a support vector machine to classify each detected face; then the engine classification based on Latent Semantic Analysis extracts a list of terms related to the concepts expressed in the accompanying text, which is associated to the list of recognised faces in the image(s); for each video, the title and accompanying text is extracted and classified by applying the Latent Semantic Analysis algorithm.

8) A computer system and a method for searching, publishing and managing the life cycle of multimedia content related to public events and the user experience as claims 3), 6), 7) characterised by the fact that the extracted content is subjected to a tag-enrichment process, with key terms extracted from other information; within the graph structure new nodes are formed when concepts which are not yet present in the knowledge base are detected, or an enrichment forms of the existing nodes with new elements, when concepts are already present; in both cases, an updated version of the knowledge base is produced containing text, images and videos associated with pre-existing concepts or new concepts.

9) A computer system and a method for searching, publishing and managing the life cycle of multimedia content related to public events and the user experience as claim 3) characterised by the fact that the second component (ω) of the algorithm is used to produce a partitioned and customised environment of the knowledge base for each individual user through a browseable graph of concepts associated to a specific event, such a graph is a subset of the knowledge base related to the researched content.

10) A computer system and a method for searching, publishing and managing the life cycle of multimedia content related to public events and the user experience as claim 3) characterised by the fact that the the part pipeline (ω) of the algorithm consists of programs for the ‘user profiling, which allow the knowledge base partition with extracting user preferences by accessing and collecting data from the Facebook profile and/or Instagram and other social networks; direct integration of user preferences through the use of appropriate user interfaces and manual selection of favourite topics presented in the form of tag list; construction of the user's preference map performed using a matching graph between user preferences and Atlas knowledge concepts.

11) A computer system and a method for searching, publishing and managing the life cycle of multimedia content related to public events and the user experience as claim 3), 9) characterised by the fact that the part pipeline (ω) of the algorithm It is composed of a program that adopts a collaborative filtering technique producing triple-type data as follows: User, Item, Rating; the triple-type data set is stored on a database used for storing all preferences expressed by users; for every preference expressed, the KNN algorithm (K-Nearest Neighbour) is applied to define or update the community reference preference; all content classified below coherence rating i.e. a definable threshold, will not be shown any longer to users of the community.
